(19) United States
(12) Patent Application Publication
(10) Pub. No.: US 2026/0267924 A1
(43) Pub. Date: Sep. 10, 2026

(54) MACHINE LEARNING-BASED SEARCH APPARATUS, SEARCH METHOD, AND MEDIUM FOR SUPPORTING DECISION MAKING

(71) Applicant: NEC Corporation, Tokyo (JP)

(72) Inventors: Taku FUJITOMI, Tokyo (JP); Makoto TERAO, Tokyo (JP); Takashi SHIBATA, Tokyo (JP); Naoya SOGI, Tokyo (JP)

(73) Assignee: NEC Corporation, Tokyo (JP)

(21) Appl. No.: 19/408,490

(22) Filed: Dec. 4, 2025

(30) Foreign Application Priority Data
Mar. 6, 2025 (JP) 2025-035867

(51) Int. Cl. G06F 16/9035; G06F 16/9038

(52) U.S. Cl. CPC G06F 16/9035; G06F 16/9038

(57) ABSTRACT

This disclosure provides a machine learning-based search apparatus for supporting decision making. The search apparatus includes a memory and one or more processors. The memory is configured to store instructions. The one or more processors are configured to execute the instructions stored in the memory. The instructions include instructions to: determine confidence of each of one or more search results for a query according to similarities indicating degrees of consistency between the one or more search results and the query; and output a search result the confidence of which satisfies a display criterion from among the one or more search results.

This application is based upon and claims the benefit of priority from Japanese Patent Application No. 2025-035867, filed on Mar. 6, 2025, the disclosure of which is incorporated herein in its entirety by reference.

### TECHNICAL FIELD

The present disclosure relates to a search apparatus, a search method, and a medium.

### BACKGROUND ART

Examples of a technique for excluding search results unrelated to the query include the technique described in Rossi et al., Relevance Filtering for Embedding-based Retrieval, arXiv: 2408.04887v1, 9 Aug. 2024. Rossi et al., Relevance Filtering for Embedding-based Retrieval, arXiv: 2408.04887v1, 9 Aug. 2024 describes that a query and search results are embedded in a vector space, cosine similarities of obtained vectors are calculated, and the cosine similarities are converted by a conversion function based on the query to order the search results. In the technique described in Rossi et al., Relevance Filtering for Embedding-based Retrieval, arXiv: 2408.04887v1, 9 Aug. 2024, there are issues that it is necessary to manually prepare a correct answer label indicating correctness for all search results, and a threshold needs to be set manually in order to perform display satisfying such a criterion.

### SUMMARY

The present disclosure has been made in view of the above issues, and an example object thereof is to provide a technique for outputting search results satisfying a display criterion.

A search apparatus according to an exemplary aspect of the present disclosure includes: calculation means for determining confidence of each of one or more search results for a query according to similarities indicating degrees of consistency between the one or more search results and the query, and extraction means for outputting a search result the confidence of which satisfies a display criterion from among the one or more search results.

A search method according to an exemplary aspect of the present disclosure includes: determining confidence of each of one or more search results for a query according to similarities indicating degrees of consistency between the one or more search results and the query, and outputting a search result the confidence of which satisfies a display criterion from among the one or more search results.

A search program according to an exemplary aspect of the present disclosure causes a computer to function as a search apparatus and to perform: calculation processing for determining confidence of each of one or more search results for a query according to similarities indicating degrees of consistency between the one or more search results and the query, and extraction processing for outputting a search result the confidence of which satisfies a display criterion from among the one or more search results.

### BRIEF DESCRIPTION OF THE DRAWINGS

FIG. 1 is a block diagram illustrating a configuration of a search apparatus according to the present disclosure;

FIG. 2 is a flowchart illustrating a flow of a search method according to the present disclosure;

FIG. 3 is a block diagram illustrating a configuration of a search apparatus according to the present disclosure;

FIG. 4 is a flowchart illustrating a flow of a search method according to the present disclosure;

FIG. 5 is a flowchart illustrating a flow of a search method according to the present disclosure;

FIG. 6 is a flowchart illustrating a flow of a search method according to the present disclosure;

FIG. 7 is a block diagram illustrating a configuration of a search apparatus according to the present disclosure;

FIG. 8 is a flowchart illustrating a flow of a search method according to the present disclosure;

FIG. 9 is a graph for describing an example of a calibration method according to the present disclosure;

FIG. 10 is a graph for describing an example of a calibration method according to the present disclosure;

FIG. 11 is a flowchart illustrating a flow of a search method according to the present disclosure;

FIG. 12 is a block diagram illustrating a configuration of a search apparatus according to the present disclosure;

FIG. 13 is a block diagram illustrating a configuration of a search apparatus according to the present disclosure; and

FIG. 14 is a block diagram illustrating a configuration of a computer that functions as a search apparatus according to the present disclosure.

### EXAMPLE EMBODIMENT

Hereinafter, example embodiments of the present invention will be described. However, the present invention is not limited to the following example embodiments, and various modifications can be made within a scope described in the claims. For example, example embodiments obtained by appropriately combining techniques (some or all of things or methods) adopted in the following example embodiments can also be included in the scope of the present invention. Example embodiments obtained by appropriately omitting some of the techniques adopted in the following example embodiments can also be included in the scope of the present invention. Effects mentioned in the following example embodiments are examples of effects expected in the example embodiments, and do not define extension of the present invention. That is, example embodiments that do not achieve the effects mentioned in the following example embodiments can also be included in the scope of the present invention.

### First Example Embodiment

A first example embodiment that is an example of example embodiments of the present invention will be described in detail with reference to the drawings. The present example embodiment is a basic form of each example embodiment to be described below. An application range of each of techniques adopted in the present example embodiment is not limited to the present example embodiment. That is, each technique adopted in the present example embodiment can also be adopted in other example embodiments included in the present disclosure as long as no particular technical problem occurs. Each technique illustrated in the drawings referred to for describing the present example embodiment can also be adopted in other example embodiments included in the present disclosure as long as no particular technical problem occurs.

A search apparatus 1 is an apparatus that outputs search results satisfying a display criterion from among one or more search results for a query.

Examples of the “display criterion” include, but are not particularly limited to, a criterion related to confidence probability, a precision, a recall, and an F measure.

The “display criterion” may be a criterion that an evaluation value such as the confidence probability, the precision, the recall, or the F measure is within a range of a predetermined error width (%) (allowable error width) from a predetermined ratio (%) (first display criterion), and that an evaluation value different from the first display criterion such as the confidence probability, the precision, the recall, or the F measure is maximum (second display criterion).

The application of the search apparatus 1 is not particularly limited, and can be suitably used in various search apparatus or search systems. In particular, for example, in a case where search is performed from a large number of site photographs or in a case where it is necessary to reflect search results on a map in order to grasp a disaster situation, it is advantageous to display search results as many as the number of search results to be output satisfying the display criterion of a user, and thus, the search apparatus 1 can be suitably used. The same applies to a case where search is performed in police investigation support or media handling a large number of moving images.

### (Configuration of Search Apparatus)

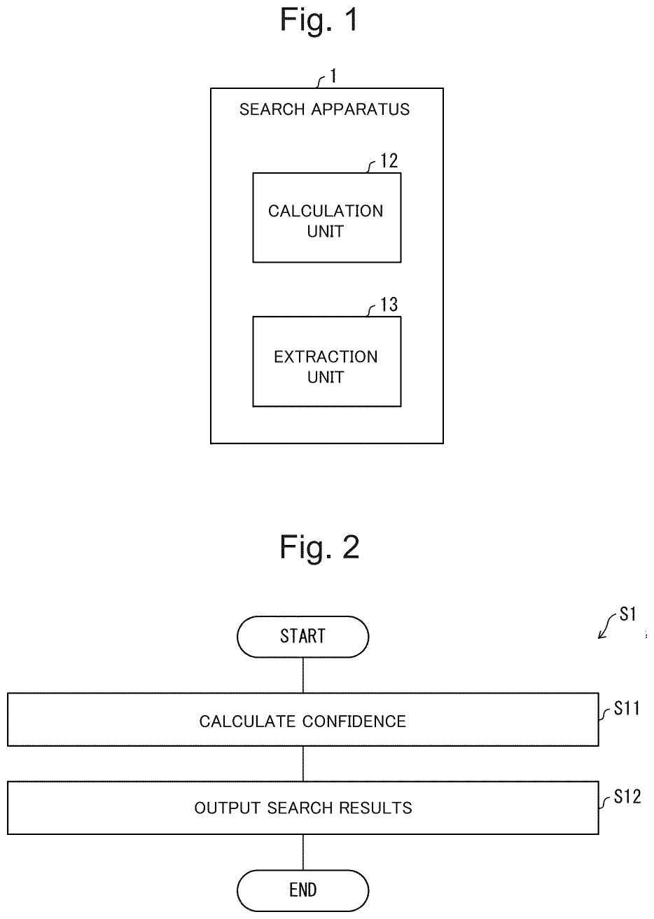

A configuration of a search apparatus 1 will be described with reference to FIG. 1. FIG. 1 is a block diagram illustrating a configuration of the search apparatus 1. As illustrated in FIG. 1, the search apparatus 1 includes a calculation unit 12 and an extraction unit 13.

The calculation unit 12 calculates, for each of one or more search results, confidence of the search result from a similarity indicating the degree of consistency between the search result and the query.

The “similarity indicating the degree of consistency between the search result and the query” is an index indicating how similar the search result and what the query indicates are semantically. For example, cosine similarity between embedded vectors embedded in a vector space, a relevance calculated by an algorithm such as BM25, or the like can be used. The data formats of the search results and the query may be the same or different.

“Confidence of search result” indicates an estimated probability that the search result is a correct search result for the query.

The extraction unit 13 outputs search results satisfying a display criterion based on the confidence of each of one or more search results.

“Search results satisfying the display criterion are output” indicates that search results are output in such a way that the output search results satisfy the display criterion. Alternatively, “search results satisfying the display criterion are output” indicates that search results are selected and output in such a way that the output search results satisfy the display criterion.

### (Effects of Search Apparatus)

As described above, the search apparatus 1 is configured to calculate the confidence from the similarities of the search results and output the search results based on the confidence. Therefore, according to the search apparatus 1, an effect that search results satisfying the display criterion can be output is obtained.

### (Flow of Search Method)

A flow of a search method S1 will be described with reference to FIG. 2. FIG. 2 is a flowchart illustrating the flow of the search method S1. The search method S1 is a method of outputting search results satisfying a display criterion from among one or more search results for a query, and may be performed by the search apparatus 1. As illustrated in FIG. 2, the search method S1 includes calculation processing S11 and extraction processing S12.

The calculation processing S11 calculates, for each of one or more search results, confidence of the search result from a similarity indicating the degree of consistency between the search result and the query.

The extraction processing S12 outputs search results satisfying a display criterion based on the confidence of each of one or more search results.

### (Effect of Search Method)

As described above, in the search method S1, the confidence is calculated from the similarities of the search results and the search results are output based on the confidence. Therefore, according to the search method S1, an effect equivalent to that of the search apparatus 1 can be obtained.

### Second Example Embodiment

A second example embodiment that is an example of the example embodiments of the present invention will be described in detail with reference to the drawings. Components having the same functions as the components described in the above-described example embodiment are denoted by the same reference signs, and the description thereof will be appropriately omitted. An application range of each of techniques adopted in the present example embodiment is not limited to the present example embodiment. That is, each technique adopted in the present example embodiment can also be adopted in other example embodiments included in the present disclosure as long as no particular technical problem occurs. Each technique illustrated in each of the drawings referred to for describing the present example embodiment can be adopted in other example embodiments included in the present disclosure as long as no particular technical problem occurs.

### (Configuration of Search Apparatus)

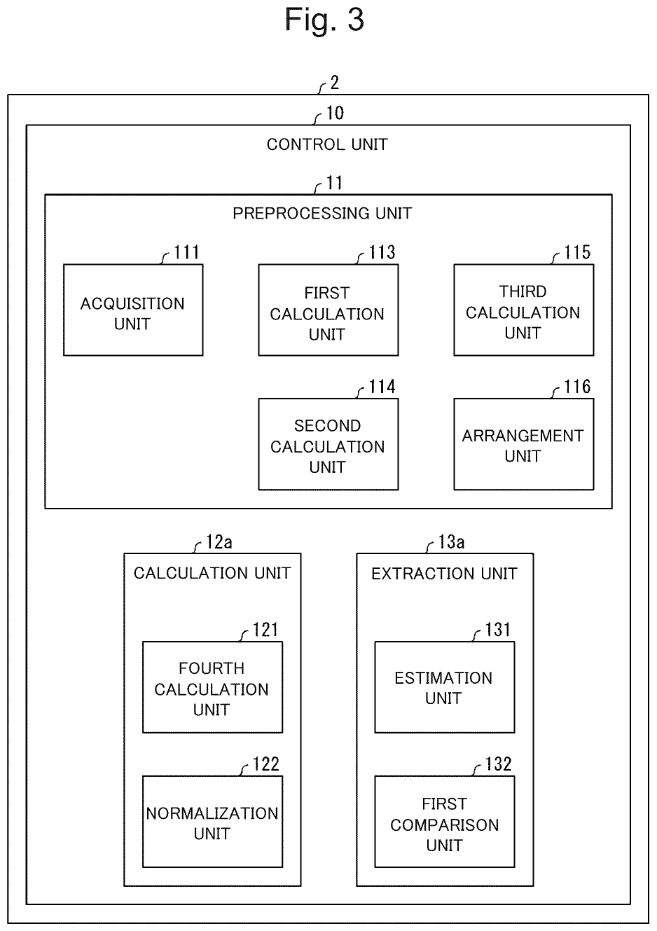

A configuration of a search apparatus 2 will be described with reference to FIG. 3. FIG. 3 is a block diagram illustrating a configuration of the search apparatus 2.

The search apparatus 2 includes a control unit 10. The control unit 10 includes a preprocessing unit 11, a calculation unit 12a, and an extraction unit 13a. The preprocessing unit 11 includes an acquisition unit 111, a first calculation unit 113, a second calculation unit 114, a third calculation unit 115, and an arrangement unit 116. The calculation unit 12a includes a fourth calculation unit 121 and a normalization unit 122. The extraction unit 13a includes an estimation unit 131 and a first comparison unit 132.

The acquisition unit 111 acquires a query, a search result column including one or more search results for the query, and a display criterion.

The query and the display criterion may be an input received by the acquisition unit 111 from a user through an input apparatus (not illustrated), or may be acquired from another apparatus by the acquisition unit 111. The one or more search results for the query may be obtained by the acquisition unit 111 as a result of searching a database using the query, or may be obtained by the acquisition unit 111 from another apparatus.

The first calculation unit 113 embeds a query in a specific vector space and calculates a query vector. The first calculation unit 113 may execute embedding processing into a specific vector space using a neural network model.

The second calculation unit 114 embeds each of one or more search results included in the search result column in a specific vector space and calculates a search result vector. The second calculation unit 114 may execute embedding processing into a specific vector space using a neural network model.

The neural network models used by the first calculation unit 113 and the second calculation unit 114 may be the same or different, but in a case where the data formats of the query and the search result are different (for example, text and image), different neural network models are preferably used.

The third calculation unit 115 calculates a similarity indicating a degree of consistency between each search result and the query by calculating a similarity (for example, cosine similarity) between the query vector and the search result vector. Then, the third calculation unit 115 calculates a similarity column including the similarity of each search result.

The arrangement unit 116 rearranges (sorts) the search result column and the similarity column. In the following description, in the similarity column, the similarities are arranged in descending order based on the similarities. In the search result column, the search results are arranged in descending order based on the similarities related to the search results. However, the arrangement orders in the search result column and the similarity column are not limited thereto, and may be any arrangement order based on the similarity, and may be ascending order.

The calculation unit 12a calculates the confidence of each of the search results included in the similarity column from the similarity of the search result. In one aspect, the calculation unit 12a calculates a confidence column by converting each similarity to, for example, confidence indicated by a value that is equal to or more than 0.0 and equal to or less than 1.0.

Specifically, first, the fourth calculation unit 121 determines the maximum value of the similarity and the minimum value of the similarity. The fourth calculation unit 121 may determine the maximum value in the similarity column as the maximum value of the similarity, or may determine a predetermined value as the maximum value of the similarity. The fourth calculation unit 121 may determine the minimum value in the similarity column as the minimum value of the similarity, or may determine a predetermined value as the minimum value of the similarity.

Subsequently, the normalization unit 122 converts the similarity s into the confidence p of equal to or more than 0.0 and equal to or less than 1.0 by the following Expression (1) using the maximum value max of the similarities and the minimum value min of the similarities, thereby calculating a confidence column.

$$[ Math . 1 ]$$

$$p = \frac{s - min}{max - min} \qquad ( 1 )$$

The extraction unit 13a calculates the number of search results to be output satisfying the display criterion based on the confidence of each search result included in the confidence column.

Specifically, first, the estimation unit 131 estimates a confusion matrix for each candidate for the number of search results to be output. In one aspect, the candidate for the number of search results to be output may be each integer from 1 to N (N is the total number of search results included in the search result column).

The “confusion matrix” is a matrix in which the results of the binary classification are put together, and is expressed by the following Expression (2).

$$[ Math . 2 ]$$

$$( \begin{matrix}TP & FN \\ FP & TN\end{matrix} ) \qquad ( 2 )$$

TP represents the number of correct search results (the number of true positives) in the extracted targets. FP represents the number of incorrect search results (the number of false positives) in the extracted targets. FN represents the number of correct search results (the number of false negatives) in the non-extracted targets. TN represents the number of incorrect search results (the number of true negatives) in the non-extracted targets. The evaluation values such as the precision, the recall, and the F measure can be calculated from the confusion matrix. The F measure may be F1 or another F measure.

Here, in the search result column, not all the search results are manually attached with correct labels indicating whether the search results are correct. Therefore, in the related art, the number of correct answers and the number of incorrect answers are not determined, so that it is not possible to directly calculate the confusion matrix described above, and it is difficult to calculate the evaluation value described above. On the other hand, the search apparatus 2 can calculate the above-described evaluation value by estimating the confusion matrix based on the confidence.

That is, the estimation unit 131 calculates the following values (1) to (4) for each candidate for the number of search results to be output based on the confidence column.
(1) Estimated number of correct search results (expected value of TP) included in candidates for search results to be output related to candidates for the number of search results to be output
(2) Estimated number of incorrect search results (expected value of FP) included in candidates for search results to be output
(3) Estimated number of correct search results (expected value of FN) included in search result column excluding candidates for search results to be output
(4) Estimated number of incorrect search results (expected value of TN) included in search result column excluding candidates for search results to be output

In one aspect, “the candidates for the search results extracted based on the candidates for the number of search results to be output” are the search results corresponding to a candidate number of the search results to be output from the head of the search result column. When the search result column is in ascending order, these are the search results corresponding to a candidate number of the search results to be outputted from the end of the search result column.

Since the confidence of the search result imitates the probability that the search result is correct (probability of being correct), the confidence can be used as the probability of being correct. Correct can be regarded as one correct search result, and incorrect can be regarded as zero correct search result.

Therefore, in one aspect, the estimation unit 131 can estimate the confusion matrix by calculating the expected value of each element (TP, FP, FN, and TN) of the confusion matrix for each candidate for the number of search results to be output as follows. N indicates the total number of search results included in the search result column. Nₚ indicates a candidate for the number of search results to be output.

$$Expected value of TP = 1 \times ( first confidence of confidence column ) + 1 \times ( second confidence of confidence column ) + … + 1 \times ( {N}_{p} - th confidence of confidence column ) \qquad ( 1 )$$

In other words, the expected value of TP is the sum of probabilities of being correct of the Nₚ search results that are candidates for the search result to be output.

$$Expected value of F P = 1 \times ( 1 - ( first confidence of confidence column ) ) + 1 \times ( 1 - ( second confidence of confidence column ) ) + … + 1 \times ( 1 - ( {N}_{p} - th confidence of confidence column ) ) \qquad ( 2 )$$

(1-confidence) is the probability of being incorrect, and thus, in other words, the expected value of FP is the sum of the probabilities of being incorrect of the Nₚ search results that are candidates for the search result to be output.

$$Expected value of FN = 1 \times ( ( {N}_{p} + 1 ) - th confidence of confidence column ) + 1 \times ( ( {N}_{p} + 2 ) - th confidence of confidence column ) + … + 1 \times ( N - th confidence of confidence column ) \qquad ( 3 )$$

In other words, the expected value of FN is the sum of the probabilities of being correct of (N−Nₚ) search results other than the candidates for the search result to be output.

$$Expected value of T N = 1 \times ( ( {N}_{p} + 1 ) - th confidence of confidence column ) ) + 1 \times ( 1 - ( ( {N}_{p} + 2 ) - th confidence of confidence column ) ) + … + 1 \times ( 1 - ( N - th confidence of confidence column ) ) \qquad ( 4 )$$

In other words, the expected value of TN is the sum of the probabilities of being incorrect of (N−Nₚ) search results other than the candidates for the search result to be output.

Then, the estimation unit 131 estimates a confusion matrix for each of candidates for the number of search results to be output from 1 to N (N is the total number of search results included in the search result column), and outputs the confusion matrixes as a column of the confusion matrixes to the first comparison unit 132 together with the column of the candidates for the number of search results to be output.

The first comparison unit 132 calculates, for each candidate for the number of search results to be output, one or a plurality of evaluation values defined by the display criterion from each element of the confusion matrix based on, for example, the following Expressions (3) to (5), or the like.

$$[ Math . 3 ]$$

$$Precison = \frac{TP}{TP + FP} \qquad ( 3 )$$

$$[ Math . 4 ]$$

$$Recall = \frac{TP}{TP + FN} \qquad ( 4 )$$

$$[ Math . 5 ]$$

$$F 1 = 2 \times \frac{Precision \times Recall}{Precision + Recall} \qquad ( 5 )$$

Then, the first comparison unit 132 specifies candidates for the number of search results to be output having one or more evaluation values satisfying the display criterion, and outputs the candidate as the number of search results to be output calculated by the extraction unit 13a.

In one aspect, the display criterion may be a condition such as the evaluation value having the smallest difference from the reference value, the evaluation value being the smallest among those exceeding the reference value, or the evaluation value being the maximum.

The extraction unit 13a extracts, from the search result column, search results to be output based on the number of search results to be output. In one aspect, the extraction unit 13a may extract, from the search result column, the search results to be output based on the number of search results to be output. Specifically, the extraction unit 13a may extract, as the search results to be output, the search results corresponding to the number of the search results from the head of the search results column. When the search result column is in ascending order, these are the search results corresponding to the number of the search results to be output from the end of the search result column.

The extraction unit 13a may cause a display apparatus (not illustrated) to display the search results to be output, or may transmit the search results to be output to another apparatus via a communication path.

### (Flow of Operation of Search Apparatus)

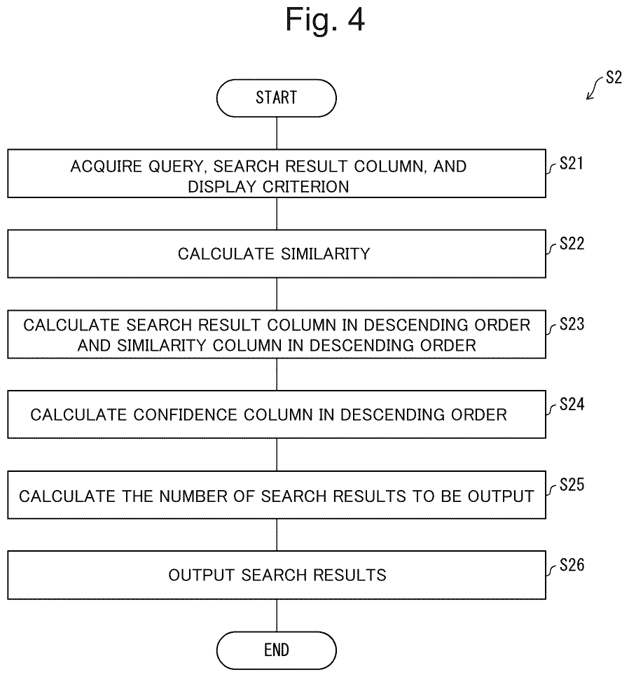

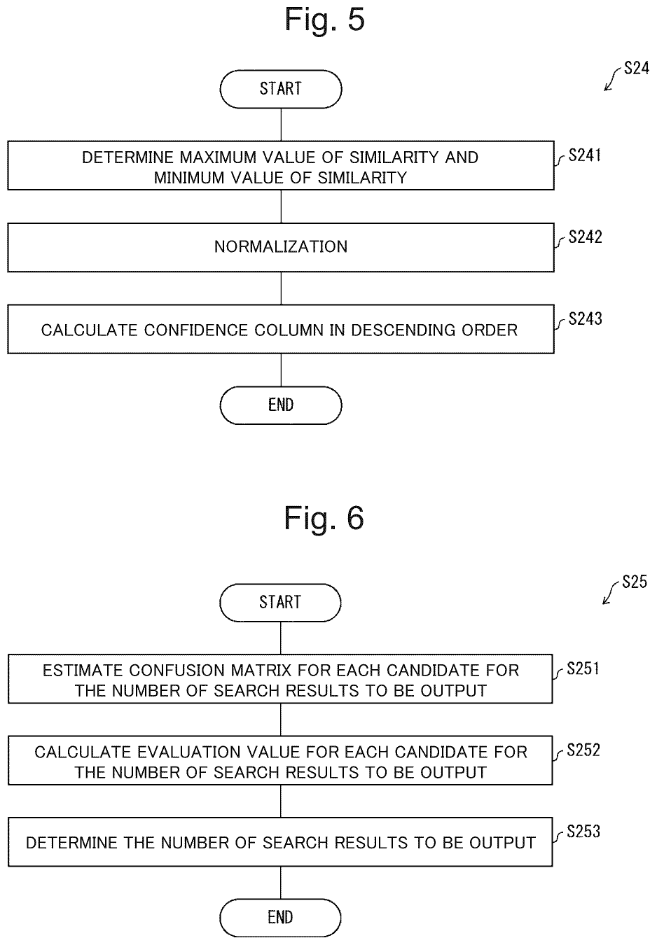

The flow of the operation of the search apparatus 2 will be described with reference to FIGS. 4 to 6. FIG. 4 is a flowchart illustrating the flow of a search method S2. FIG. 5 is a flowchart illustrating the flow of step S24 of the search method S2. FIG. 6 is a flowchart illustrating the flow of step S25 of the search method S2.

In the following, as an example, a case where the search result column includes a search result a (correct), a search result b (incorrect), and a search result c (correct), and the displayed criterion is a criterion that the recall is the closest to 0.95 and the precision is the maximum will be described, but the present example embodiment is not limited to the example.

First, description will be made with reference to FIG. 4. In step S21, the acquisition unit 111 acquires a query, the search result column (a, b, c), and the display criterion.

In step S22, the first calculation unit 113 calculates the query vector, the second calculation unit 114 calculates the search result vector, and the third calculation unit 115 calculates the similarities based on the query vector and the search result vector, thereby calculating the similarity column (a: 0.5, b: 0.1, c: 0.4).

In step S23, the arrangement unit 116 rearranges the search result column and the similarity column based on the similarities, thereby calculating a similarity column (a: 0.5, c: 0.4, b: 0.1) in descending order and a search result column (a, c, b) arranged in descending order.

In step S24, the calculation unit 12a calculates a confidence column in descending order.

Specifically, as illustrated in FIG. 5, in step S241, the fourth calculation unit 121 determines the maximum value (0.5) of the similarities and the minimum value (0.1) of the similarities. Then, in step S241, the normalization unit 122 converts the similarities of the similarity column (a: 0.5, c: 0.4, b: 0.1) in descending order into the confidence using the maximum value (0.5) of the similarities and the minimum value (0.1) of the similarities, and in step S243, the calculation unit 12a calculates the confidence column (a: 1.0, c: 0.75, b: 0.0) in descending order.

Referring again to FIG. 4, in step S25, the extraction unit 13a calculates the number of search results to be output satisfying the display criterion based on the confidence of each search result included in the confidence column in descending order.

Specifically, as illustrated in FIG. 6, in step S251, the estimation unit 131 estimates the confusion matrix for each candidate (1 to 3) of the number of search results to be output based on the confidence column (a: 1.0, c: 0.75, b: 0.0) in descending order. The confusion matrix related to the candidate 1 of the number of search results to be output is estimated as (TP=1.0, FP=1-1.0, FN=0.75+0.0, TN=(1-0.75)+ (1-0.0)), the confusion matrix related to the candidate 2 of the number of search results to be output is estimated as (TP=1.0+0.75, FP=(1-1.0)+ (1-0.75), FN=0.75+0.0, TN=1-0.0), and the confusion matrix related to the candidate 3 of the number of search results to be output is estimated as (TP=1.0+0.75+0.0, FP=(1-1.0)+ (1-0.75)+ (1-0.0), FN=0, TN=0).

In step S252, the first comparison unit 132 calculates an evaluation value for each candidate for the number of search results to be output based on the confusion matrix estimated by the estimation unit 131. The evaluation value related to candidate 1 of the number of search results to be output is calculated as (precision=1.0, recall=0.57), the evaluation value related to candidate 2 of the number of search results to be output is calculated as (precision=0.88, recall=1.0), and the evaluation value related to candidate 3 of the number of search results to be output is calculated as (precision=0.58, recall=1.0).

In step S253, the first comparison unit 132 specifies a candidate (2) of the number of search results that satisfy the display criterion (recall is closest to 0.95 and precision is maximum), and outputs the specified candidate as the number of search results to be output.

Referring again to FIG. 4, in step S26, the extraction unit 13a outputs the search results (a, c) based on the number of search results to be output (2) from the search result column (a, c, b) arranged in descending order.

### (Modification)

The acquisition unit 111 may directly acquire a search result column in descending order and a similarity column in descending order. In that case, in the preprocessing unit 11, the first calculation unit 113, the second calculation unit 114, the third calculation unit 115, and the arrangement unit 116 may be omitted.

In the above description, the search results, the similarities, and the confidence are handled as columns, but the present invention is not limited thereto. That is, as long as the search results, the similarities, and the confidence are associated with each other, the search results, the similarities, and the confidences are not necessarily handled as columns. The same applies to other example embodiments.

### Third Example Embodiment

A third example embodiment that is an example of the example embodiments of the present invention will be described in detail with reference to the drawings. Components having the same functions as the components described in the above-described example embodiments are denoted by the same reference signs, and the description thereof will be appropriately omitted. An application range of each of techniques adopted in the present example embodiment is not limited to the present example embodiment. That is, each technique adopted in the present example embodiment can also be adopted in other example embodiments included in the present disclosure as long as no particular technical problem occurs. Each technique illustrated in each of the drawings referred to for describing the present example embodiment can be adopted in other example embodiments included in the present disclosure as long as no particular technical problem occurs.

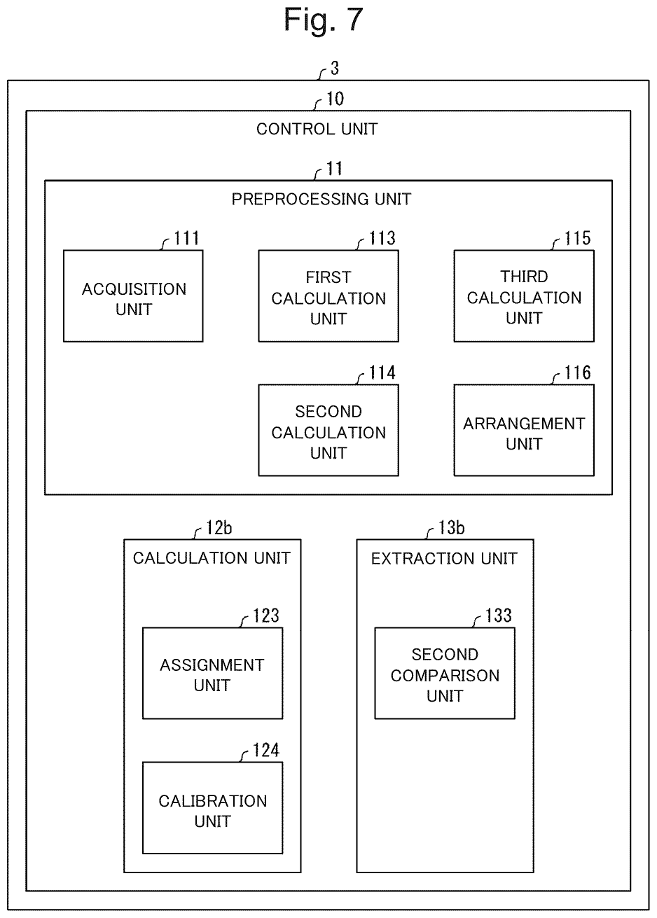

A configuration of a search apparatus 3 will be described with reference to FIG. 7. FIG. 7 is a block diagram illustrating a configuration of the search apparatus 3.

The search apparatus 3 includes a control unit 10. The control unit 10 includes a preprocessing unit 11, a calculation unit 12b, and an extraction unit 13b. The calculation unit 12b includes an assignment unit 123 and a calibration unit 124. The extraction unit 13b includes a second comparison unit 133.

The calculation unit 12b calculates the confidence of each of the search results included in the similarity column from the similarity of the search result. In one aspect, the calculation unit 12b calculates a confidence column by converting each similarity to, for example, a confidence indicated by a value that is equal to or more than 0.0 and equal to or less than 1.0.

Specifically, first, the assignment unit 123 assigns a label indicating whether a search result is estimated to be correct to at least a part of the search results included in the search result column based on the search result and the query.

In one aspect, the assignment unit 123 may assign a label obtained by inputting the search result and the query to a learned model to at least a part of the search results included in the search result column. In one aspect, the assignment unit 123 may assign a label to at least a part of the search results included in the search result column based on an input from a user.

Subsequently, the calibration unit 124 calibrates a function used to calculate the confidence from the similarity based on the label. In one aspect, the function that the calibration unit 124 calibrates is a conversion function f that converts the similarity s into the confidence p, which is expressed by the following Expression (6).

$$[ Math . 6 ]$$

$$p = f ( s ) \qquad ( 6 )$$

In one aspect, the calibration unit 124 calibrates a function used to calculate confidence from a similarity by using a label assigned in a known calibration algorithm using a label as described below.
●Histogram binning●Isotonic regression●Bayesian binning into quantiles●Platt scaling●Temperature scaling

Here, a calibration method using Histogram binning will be described. First, the calibration unit 124 generates a histogram in which the horizontal axis represents the similarity and the vertical axis represents the number of correct labels and the number of incorrect labels for each of search results to which labels are assigned. FIG. 9 illustrates an example of the histogram. Hatched portions indicate the number of correct labels, and dotted portions indicate the number of incorrect labels.

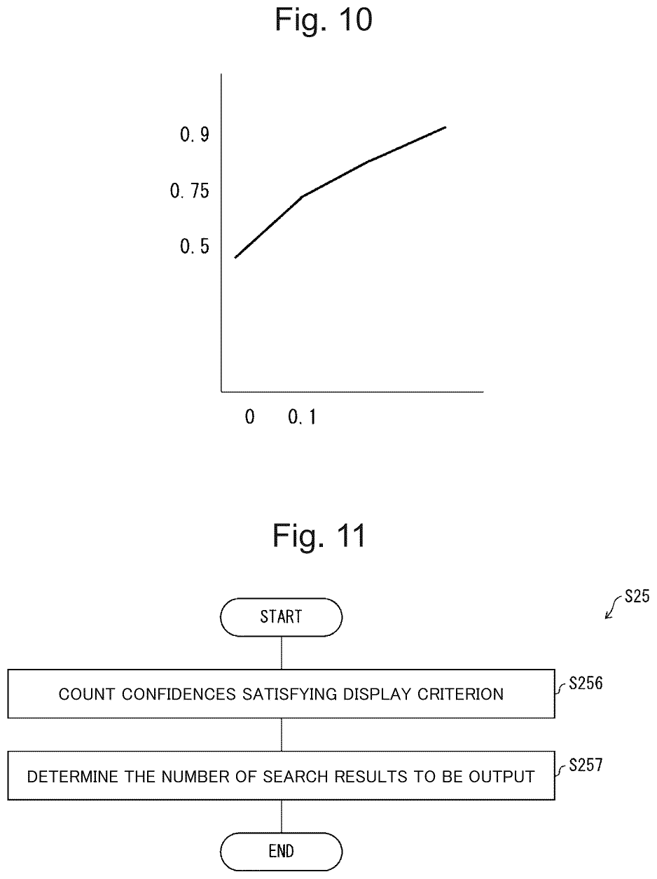

Then, based on the generated histogram, the calibration unit 124 calibrates the function used to calculate the confidence from the similarity in such a way that the relationship between the similarities and the confidence is as illustrated in FIG. 10.

Then, the calculation unit 12b calculates a confidence column by converting the similarities into the confidence using the function calibrated by the calibration unit 124.

The extraction unit 13b calculates the number of search results to be output satisfying the display criterion based on the confidence of each search result included in the confidence column.

Specifically, the second comparison unit 133 compares each confidence included in the confidence column with the threshold indicated by the display criterion, and counts the number of confidence equal to or more than the threshold. The extraction unit 13b calculates the number of confidence counted by the second comparison unit 133 as the number of search results to be output.

As described above, the search apparatus 3 includes the calculation unit 12b and the extraction unit 13b instead of the calculation unit 12a and the extraction unit 13a of the search apparatus 2. However, similarly to the search apparatus 2, the search apparatus 3 can calculate the confidence from the similarity, determine the number of search results to be output based on the confidence, and extract the search results to be displayed.

### (Flow of Operation of Search Apparatus)

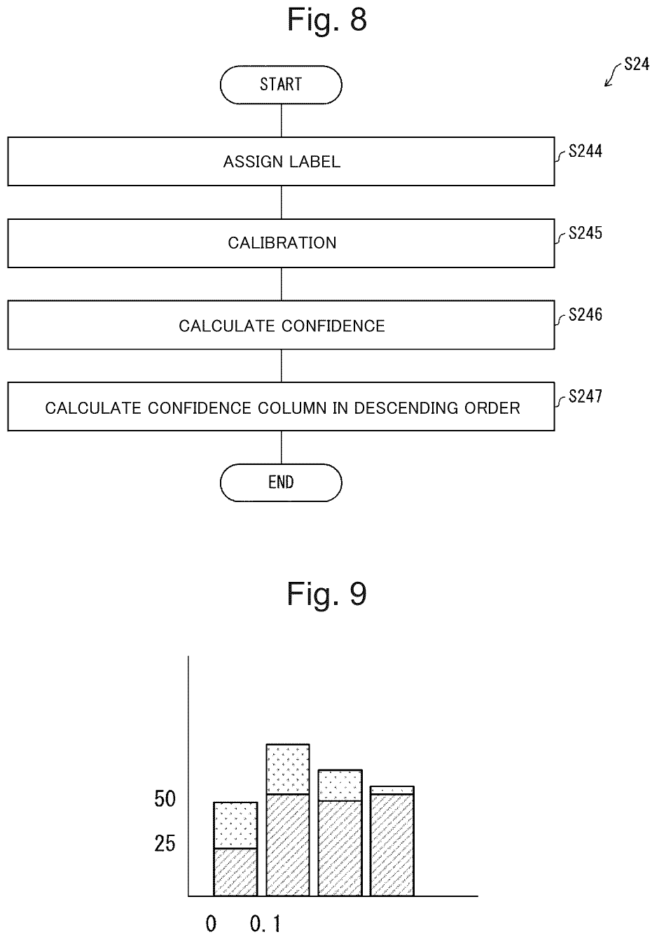

The flow of the operation of the search apparatus 3 will be described with reference to FIGS. 4, 8, and 11. FIG. 8 is a flowchart illustrating the flow of a step S24. FIG. 11 is a flowchart illustrating the flow of a step S25. The search apparatus 3 basically operates as illustrated in FIG. 4 similarly to the search apparatus 2, but the operations of steps S24 and S25 are different from those of the search apparatus 2.

In the following, as an example, a case where the search result column includes a search result a (correct), a search result b (incorrect), and a search result c (correct), and the displayed criterion is a criterion that the confidence probability is equal to or more than 0.5 will be described, but the present example embodiment is not limited to the example.

First, description will be made with reference to FIG. 4. Since steps S21 to S23 are similar to those of the second example embodiment, the description thereof will be omitted.

In step S24, the calculation unit 12b calculates a confidence column in descending order.

Specifically, as illustrated in FIG. 8, in step S244, the assignment unit 123 assigns labels (a: 1 (correct), b: 0 (incorrect)) indicating whether the search results are estimated to be correct based on the search results and the query to at least a part of search results (a, b) included in a search result column (a, c, b) in descending order. In step S245, the calibration unit 124 calibrates a function used to calculate the confidence from the similarity based on the label. Then, in step S246, the calculation unit 12b converts the similarities into the confidence using the function calibrated by the calibration unit 124, thereby calculating a confidence column (a: 1.0, c: 0.75, b: 0.0) in descending order in step S247. This result is a result in a case where the calibration unit 124 uses the Isotonic regression.

Referring again to FIG. 4, in step S25, the extraction unit 13b calculates the number of search results satisfying the display criterion based on the confidence of each search result included in the confidence column in descending order.

Specifically, as illustrated in FIG. 11, in step S256, the second comparison unit 133 compares each confidence included in the confidence column (a: 1.0, c: 0.75, b: 0.0) in descending order with the threshold (0.5) indicated by the display criterion, and counts the number (2) of confidence equal to or more than the threshold. In step S257, the extraction unit 13b calculates the number of confidence (2) counted by the second comparison unit 133 as the number of search results to be output.

Referring again to FIG. 4, in step S26, the extraction unit 13b outputs the search results (a, c) based on the number of search results to be output (2) from the search result column (a, c, b) arranged in descending order.

### Fourth Example Embodiment

A fourth example embodiment that is an example of the example embodiments of the present invention will be described in detail with reference to the drawings. Components having the same functions as the components described in the above-described example embodiments are denoted by the same reference signs, and the description thereof will be appropriately omitted. An application range of each of techniques adopted in the present example embodiment is not limited to the present example embodiment. That is, each technique adopted in the present example embodiment can also be adopted in other example embodiments included in the present disclosure as long as no particular technical problem occurs. Each technique illustrated in each of the drawings referred to for describing the present example embodiment can be adopted in other example embodiments included in the present disclosure as long as no particular technical problem occurs.

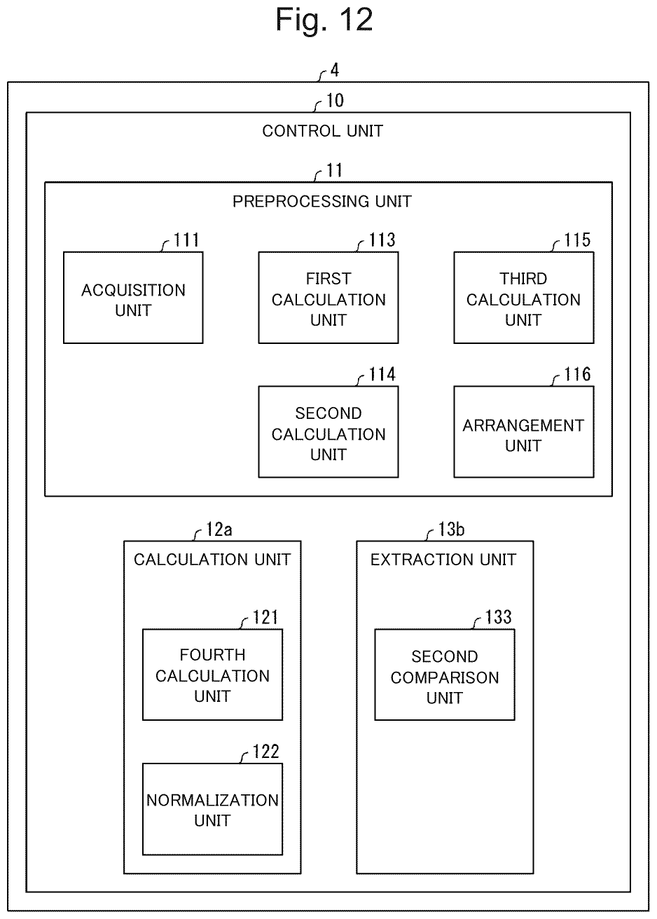

A configuration of a search apparatus 4 will be described with reference to FIG. 12. FIG. 12 is a block diagram illustrating a configuration of the search apparatus 4. The search apparatus 4 includes a control unit 10. The control unit 10 includes a preprocessing unit 11, a calculation unit 12a, and an extraction unit 13b. Even in such a configuration, similarly to the search apparatus 2, the search apparatus 4 can calculate the confidence from the similarities, determine the number of search results to be output based on the confidence, and output the search results satisfying the display criterion.

### Fifth Example Embodiment

A fifth example embodiment that is an example of the example embodiments of the present invention will be described in detail with reference to the drawings. Components having the same functions as the components described in the above-described example embodiments are denoted by the same reference signs, and the description thereof will be appropriately omitted. An application range of each of techniques adopted in the present example embodiment is not limited to the present example embodiment. That is, each technique adopted in the present example embodiment can also be adopted in other example embodiments included in the present disclosure as long as no particular technical problem occurs. Each technique illustrated in each of the drawings referred to for describing the present example embodiment can be adopted in other example embodiments included in the present disclosure as long as no particular technical problem occurs.

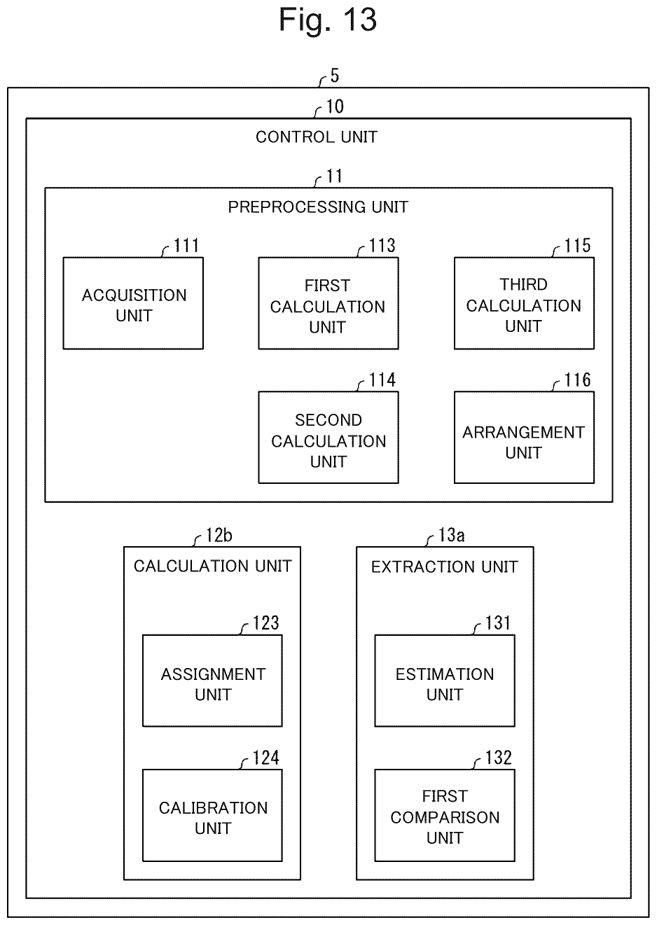

A configuration of a search apparatus 5 will be described with reference to FIG. 13. FIG. 13 is a block diagram illustrating a configuration of the search apparatus 5. The search apparatus 5 includes a control unit 10. The control unit 10 includes a preprocessing unit 11, a calculation unit 12b, and an extraction unit 13a. Even in such a configuration, similarly to the search apparatus 2, the search apparatus 5 can calculate the confidence from the similarities, determine the number of search results to be output based on the confidence, and output the search results satisfying the display criterion.

### Sixth Example Embodiment

A sixth example embodiment that is an example of the example embodiments of the present invention will be described in detail with reference to the drawings. Components having the same functions as the components described in the above-described example embodiments are denoted by the same reference signs, and the description thereof will be appropriately omitted. An application range of each of techniques adopted in the present example embodiment is not limited to the present example embodiment. That is, each technique adopted in the present example embodiment can also be adopted in other example embodiments included in the present disclosure as long as no particular technical problem occurs. Each technique illustrated in each of the drawings referred to for describing the present example embodiment can be adopted in other example embodiments included in the present disclosure as long as no particular technical problem occurs.

In the first to fifth example embodiments, a case where a first display criterion, an allowable error width for the first display criterion, and a second display criterion are set as a display criterion will be described.

In this case, in order to determine the number of search results to be output, the extraction unit 13 may hold a plurality of candidates as candidates for the number of search results to be output based on the first display criterion and the allowable error width, and determine the number of search results to be output from the plurality of candidates based on the second display criterion.

For example, in a case where the first display criterion is a criterion that a predetermined evaluation value is within an error range of a predetermined % that is the allowable error width from the predetermined %, and the second display criterion is a criterion that an evaluation value different from that for the first display criterion is the maximum, the extraction unit 13 may determine a plurality of candidates for the number of search results to be output in which a way that the predetermined evaluation value is within the error range of the predetermined % that is the allowable error width from the predetermined %, and determine the number of search results that makes the evaluation value different from that for the first display criterion the maximum as the number of search results to be output.

### Example of Implementation by Software

Some or all of the functions of the search apparatus 1 to 5 (hereinafter, also referred to as “each of the above apparatus”) may be implemented by hardware such as an integrated circuit (IC chip) or may be implemented by software.

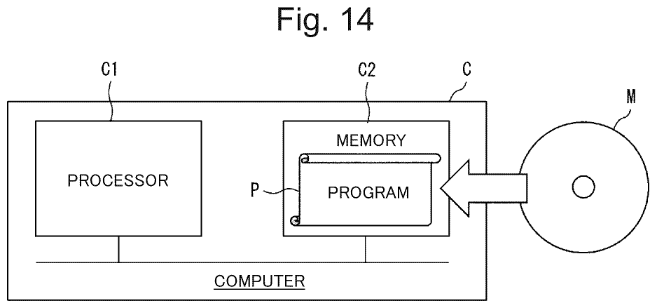

In the latter case, each of the above apparatus is implemented by, for example, a computer that executes commands of a program that is software for implementing the functions. An example of such a computer (hereinafter, referred to as a computer C) is illustrated in FIG. 14. FIG. 14 is a block diagram illustrating a hardware configuration of the computer C functioning as each of the above apparatus.

The computer C includes at least one processor C1 and at least one memory C2. A program P for causing the computer C to operate as each of the above apparatus is recorded in the memory C2. In the computer C, by the processor C1 reading the program P from the memory C2 and executing the program P, the functions of each of the above apparatus are implemented.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for loading the program P at the time of execution and temporarily storing various types of data. The computer C may further include a communication interface for sending and receiving data to and from other apparatus. The computer C may further include an input/output interface for connecting input/output apparatus such as a keyboard, a mouse, a display, and a printer.

The program P may be recorded in a non-transitory tangible recording medium M readable by the computer C. As the recording medium M as described above, for example, a tape, a disk, a card, a semiconductor memory, a programmable logic circuit, or the like can be used.

The computer C can acquire the program P via the recording medium M as described above. The program P can be transmitted via a transmission medium. As such a transmission medium, for example, a communication network, a broadcast wave, or the like can be used. The computer C can also acquire the program P via such a transmission medium.

The above functions of each of the above apparatus may be implemented by a single processor provided in a single computer, may be implemented by a plurality of processors provided in a single computer in cooperation, or may be implemented by a plurality of processors provided in a plurality of computers in cooperation. The program for causing each of the above apparatus to implement the above functions may be stored in a single memory provided in a single computer, may be stored in a plurality of memories provided in a single computer in a distributed manner, or may be stored in a plurality of memories provided in a plurality of computers in a distributed manner.

In a case where it is required to confirm enormous search results in a short time, for example, in a case where images of a disaster situation are checked, it is beneficial to reduce the number of search results and display the search results. Examples of the criterion for reducing the search results include (a) a criterion that the confidence probability is equal to or more than a predetermined % in a case where a user desires to display only search results that a user is confident in, (b) a criterion that the precision indicating the proportion of the correct search results in the search results to be displayed is equal to or more than a predetermined % in a case where a user places importance on the proportion of the correct search results, and (c) a criterion that the recall indicating the proportion of the search results to be displayed in all the correct search results is equal to or more than a predetermined % in a case where a user desires to prevent overlooking of the correct candidates.

In the technique described in Rossi et al., Relevance Filtering for Embedding-based Retrieval, arXiv: 2408.04887v1, 9 Aug. 2024, there are issues that it is necessary to manually prepare a correct answer label indicating correctness for all search results, and a threshold needs to be set manually in order to perform display satisfying such a criterion.

According to an exemplary aspect of the present disclosure, there is an exemplary effect that search results that satisfy a display criterion can be output.

### [Supplementary Information 1]

The present disclosure includes the techniques described in the following supplementary notes. However, the present invention is not limited to the techniques described in the following supplementary notes, and various modifications can be made within the scope described in the claims.

### (Supplementary Note 1)

A search apparatus including:
calculation means for determining confidence of each of one or more search results for a query according to similarities indicating degrees of consistency between the one or more search results and the query, and
extraction means for outputting a search result the confidence of which satisfies a display criterion from among the one or more search results.

### (Supplementary Note 2)

The search apparatus according to supplementary note 1, in which
in order to determine the number of search results to be output, the extraction means calculates, for each of candidates for the number of search results, based on the confidence of each of the one or more search results,
an estimated number of correct search results included in candidates for the search results to be output related to the candidates for the number of search results to be output,
an estimated number of incorrect search results included in the candidates for the search results to be output,
an estimated number of correct search results included in the one or more search results excluding the candidates for the search results to be output, and
an estimated number of incorrect search results included in the one or more search results excluding the candidates for the search results to be output.

### (Supplementary Note 3)

The search apparatus according to supplementary note 1, in which the extraction means compares the confidence of each of the one or more search results with a threshold in order to determine the number of search results to be output.

### (Supplementary Note 4)

The search apparatus according to any one of supplementary notes 1 to 3, in which the calculation means determines a maximum value and a minimum value of a similarity, and calculates the confidence from the similarity by using the maximum value and the minimum value of the similarity.

### (Supplementary Note 5)

The search apparatus according to any one of supplementary notes 1 to 3, in which the calculation means includes:
assignment means for assigning, to at least a part of the search results of the one or more search results, labels indicating whether the search results are estimated to be correct based on the search results and the query, and
calibration means for calibrating, based on the labels, a function used to calculate the confidence from the similarity.

### (Supplementary Note 6)

The search apparatus according to supplementary note 5, in which the assignment means assigns, to at least a part of the one or more search results, the labels obtained by inputting the search results and the query to a learned model.

### (Supplementary Note 7)

The search apparatus according to supplementary note 1, in which
the calculation means calculates a confidence column obtained by converting each of similarities of a similarity column into the confidence, the similarity column including the similarities of the one or more search results arranged in an order based on the similarities, and
the extraction means calculates the number of search results to be output based on the confidence column, and extracts the search results to be output based on the calculated number of search results from a search result column in which the one or more search results are arranged in an order based on the similarities of the search results.

### (Supplementary Note 8)

The search apparatus according to supplementary note 1, in which
a first display criterion, an allowable error width for the first display criterion, and a second display criterion are set, and
in order to determine the number of the search results to be output, the extraction means
holds a plurality of candidates as candidates for the number of the search results to be output based on the first display criterion and the allowable error width, and determines the number of the search results to be output from among the plurality of candidates based on the second display criterion.

### (Supplementary Note 9)

The search apparatus according to supplementary note 1, in which the display criterion is a criterion related to at least one of a precision, a recall, and an F measure.

### (Supplementary Note 10)

A search method including:
determining confidence of each of one or more search results for a query according to similarities indicating degrees of consistency between the one or more search results and the query, and outputting a search result the confidence of which satisfies a display criterion from among the one or more search results.

### (Supplementary Note 11)

A search program causing a computer to function as a search apparatus and to perform:
calculation processing for determining confidence of each of one or more search results for a query according to similarities indicating degrees of consistency between the one or more search results and the query, and
extraction processing for outputting a search result the confidence of which satisfies a display criterion from among the one or more search results.

### [Supplementary Information 2]

The present disclosure includes the techniques described in the following supplementary notes. However, the present invention is not limited to the techniques described in the following supplementary notes, and various modifications can be made within the scope described in the claims.

### (Supplementary Note 1)

A search apparatus that calculates the number of search results to be output satisfying a display criterion from among one or more search results for a query, including at least one processor,
the at least one processor performs:
calculation processing for determining confidence of each of one or more search results for a query according to similarities indicating degrees of consistency between the one or more search results and the query, and
extraction processing for outputting a search result the confidence of which satisfies a display criterion from among the one or more search results.

The search apparatus may further include a memory. The memory may store a program for causing the at least one processor to perform each type of the processing.

1. A search apparatus comprising:
a memory configured to store instructions; and
one or more processors configured to execute the instructions to:
determine confidence of each of one or more search results for a query according to similarities indicating degrees of consistency between the one or more search results and the query; and
output a search result the confidence of which satisfies a display criterion from among the one or more search results.

2. The search apparatus according to claim 1, wherein
the one or more processors are further configured to execute the instructions to:
in order to determine the number of search results to be output, calculate, for each of candidates for the number of search results, based on the confidence of each of the one or more search results;
an estimated number of correct search results included in candidates for the search results to be output related to the candidates for the number of search results to be output,
an estimated number of incorrect search results included in the candidates for the search results to be output,
an estimated number of correct search results included in the one or more search results excluding the candidates for the search results to be output, and
an estimated number of incorrect search results included in the one or more search results excluding the candidates for the search results to be output.

3. The search apparatus according to claim 1, wherein
the one or more processors are further configured to execute the instructions to:
compare the confidence of each of the one or more search results with a threshold in order to determine the number of search results to be output.

4. The search apparatus according to any one of claim 1, wherein
the one or more processors are further configured to execute the instructions to:
determine a maximum value and a minimum value of a similarity; and
calculate the confidence from the similarity by using the maximum value and the minimum value of the similarity.

5. The search apparatus according to any one of claim 1, wherein
the one or more processors are further configured to execute the instructions to:
assign, to at least a part of the search results of the one or more search results, labels indicating whether the search results are estimated to be correct based on the search results and the query; and
calibrate, based on the labels, a function used to calculate the confidence from the similarity.

6. The search apparatus according to claim 5, wherein
the one or more processors are further configured to execute the instructions to:
assign, to at least a part of the one or more search results, the labels obtained by inputting the search results and the query to a learned model.

7. The search apparatus according to claim 1, wherein
the one or more processors are further configured to execute the instructions to:
calculate a confidence column obtained by converting each of similarities of a similarity column into the confidence, the similarity column including the similarities of the one or more search results arranged in an order based on the similarities;
calculate the number of search results to be output based on the confidence column; and
extract the search results to be output based on the calculated number of search results from a search result column in which the one or more search results are arranged in an order based on the similarities of the search results.

8. The search apparatus according to claim 1, wherein
a first display criterion, an allowable error width for the first display criterion, and a second display criterion are set, and
the one or more processors are further configured to execute the instructions to:
in order to determine the number of the search results to be output, hold a plurality of candidates as candidates for the number of the search results to be output based on the first display criterion and the allowable error width; and
determine the number of the search results to be output from among the plurality of candidates based on the second display criterion.

9. A search method comprising:
determining confidence of each of one or more search results for a query according to similarities indicating degrees of consistency between the one or more search results and the query; and
outputting a search result the confidence of which satisfies a display criterion from among the one or more search results.

10. A non-transitory computer-readable recording medium storing a search program for causing a computer to execute the steps:
determining confidence of each of one or more search results for a query according to similarities indicating degrees of consistency between the one or more search results and the query; and
outputting a search result the confidence of which satisfies a display criterion from among the one or more search results.
